(19) United States
(12) Patent Application Publication
(10) Pub. No.: US 2023/0286706 A1
(43) Pub. Date: Sep. 14, 2023

(54) A RECEPTACLE

(71) Applicant: LAFFE LIMITED, Great Chesterford Essex (GB)

(72) Inventor: Mladen DZHALAZOV, Plovdiv (BG)

(73) Assignee: LAFFE LIMITED, Great Chesterford Essex (GB)

(21) Appl. No.: 18/006,677

(22) PCT Filed: Apr. 8, 2021
(86) PCT No.: PCT/EP2021/059137

§ 371 Date: Jan. 24, 2023

(30) Foreign Application Priority Data
Apr. 8, 2020 (GB) 2005206.4

(51) Int. Cl. B65D 43/02; B65D 65/46; B65D 1/26

(52) U.S. Cl. CPC B65D 43/022; B65D 65/466; B65D 65/463; B65D 43/0218; B65D 43/0222; B65D 43/0229; B65D 43/0231; B65D 1/265; B65D 2543/00046; B65D 2543/00092; B65D 2543/00509; B65D 2543/00555; B65D 2543/00537

(57) ABSTRACT

There is disclosed a receptacle (10) comprising: a container (20) having an opening (28), the opening having a circular profile; and a lid (50) for closing the opening of the container; wherein the lid and container are configured to lock together with a rotational friction lock, the rotational friction lock comprising a protruding locking tab (30) on a surface of the container or the lid and a locking surface profile (68) defined on the other of the lid or the container; wherein the locking surface is configured to oppose the locking tab when the lid closes the opening of the container, the locking surface having a locking portion (74), and the locking portion having a continuous surface with a varying radius such that friction between the locking tab and the locking portion varies on relative rotation between the lid and the container.

The present invention relates to a receptacle for containing a fluid.

Receptacles, for holding fluids for example, typically comprise a container and a lid. The container and the lid are often configured to lock together, and this locking is often in the form of a snap fit or a screw thread.

According to a first aspect, there is provided a receptacle comprising: a container having an opening, the opening having a circular profile; and a lid for closing the opening of the container; wherein the lid and container are configured to lock together with a rotational friction lock, the rotational friction lock comprising a protruding locking tab on a surface of the container or the lid and a locking surface profile defined on the other of the lid or the container; wherein the locking surface is configured to oppose the locking tab when the lid closes the opening of the container, the locking surface having a locking portion, and the locking portion having a continuous surface with a varying radius such that friction between the locking tab and the locking portion varies on relative rotation between the lid and the container.

The receptacle may be for containing a fluid and/or food. The receptacle may be fluid tight. The locking tabs may be on the container, and the lid may define the locking surface profile having the locking portion.

The lid may comprise a lid base and a lid side extending from the base. The lid side may terminate at a lid rim. The locking surface may be defined on the lid side and may define a frustoconical shape such that an outer diameter of the lid side increases from the lid rim towards the lid base.

The locking tabs may be disposed on an inner surface of the container. The locking portion of the lid may be on an outer surface of the lid. This ensures that the lid can comprise reinforcing buttresses on an inner surface of the lid.

The locking surface may comprise a stop adjacent to the locking portion, to limit rotation of the lid with respect to the container.

The locking surface profile may comprise a receiving portion adjacent to the locking portion which is configured to receive the locking tab with minimal friction when the lid is initially placed on the opening of the container. There may be a locking portion disposed on either side of the receiving portion.

There may be at least two locking tabs, and at least two corresponding locking portions.

The lid and/or the container may be made of biodegradable material. The lid and/or the container may be made of edible material. The lid and/or the container may comprise a baked material. The lid/and or the container may be formed with a punch die. The lid/and or the container may be formed with any suitable mould.

The lid or the container may comprises material which becomes adhesive on contact with liquid, such as potato flour, corn flour, wheat flour, rice flour, rye flour, oat flour, oat bran flour or potato starch, corn starch, wheat starch, rice starch, rye starch, oat starch or a combination of these. The lid or the container may comprise material including an acid in combination with starch. The locking surface may be coated with an edible adhesive.

The container opening may be defined by a rim, and the lid may comprise a rim stop protruding from a surface of the lid. The rim stop may be configured to rest on the rim of the container when the lid is received in the container opening. An upper surface of the rim which is configured to oppose the rim stop and/or a lower surface of the rim stop which is configured to oppose the rim may be coated with an edible adhesive. The container may comprise a rim stop defined by a shelf protruding from an inner surface of the container.

The container may extend from a base to the rim along a central axis. The rim stop of the lid may configured to extend around the rim when the lid is received in the opening of the container, such that the rim is sandwiched between the locking portion and the rim stop in a direction perpendicular to the central axis.

The container and the lid may be configured to lock together with only the rotational friction lock, such that there are no portions of the container which are captive between portions of the lid along the central axis; and there are no portions of the lid which are captive between portions of the container along the central axis, when the container and the lid are locked together.

In other words, the container may not be sandwiched between portions of the lid along the central axis, and the lid is not sandwiched between portions of the container along the central axis, when the container and the lid are locked together.

The container may extend from a base to the opening along a central axis, wherein the locking tab protrudes from the surface of the container or the lid such that the radius, from the central axis, of the surface of the locking tab is constant along the central axis, or such that the radius of the surface of the locking tab increases along the central axis from the base.

The lid may comprise a lid base and a lid side extending from the base. The lid side may terminate at a lid rim. The lid side may comprise a locking portion adjacent the lid rim, and a holding portion adjacent the locking portion. An outer surface of the holding portion may comprise a diameter which is smaller than a diameter of an inner surface of the locking portion.

According to a second aspect, there is provided a receptacle comprising: a container having an opening, the opening having a circular profile and the container extending from a base to the opening along a central axis; and a lid for closing the opening of the container; wherein the lid and container are configured to lock together with only a rotational friction lock, the rotational friction lock comprising a protruding locking tab on a surface of the container or the lid and a locking surface profile defined on the other of the lid or the container, such that there are no portions of the container which are captive between portions of the lid along the central axis; and there are no portions of the lid which are captive between portions of the container along the central axis, when the container and the lid are locked together; wherein the locking surface is configured to oppose the locking tab when the lid closes the opening of the container, the locking surface having a locking portion, and the locking portion having a continuous surface with a varying radius such that friction between the locking tab and the locking portion varies on relative rotation between the lid and the container.

According to a third aspect, there is provided a receptacle comprising a container having an opening, the opening having a circular profile; and a lid for closing the opening of the container; wherein the lid and container are configured to lock together with a rotational friction lock, the rotational friction lock comprising a protruding locking tab on a surface of the container or the lid and a locking surface profile defined on the other of the lid or the container; wherein the locking surface is configured to oppose the locking tab when the lid closes the opening of the container, the locking surface having a locking portion, and the locking portion having a continuous surface with a varying radius such that friction between the locking tab and the locking portion varies on relative rotation between the lid and the container, wherein the lid or the container comprises material which becomes stickier on contact with liquid.

The second and third aspects may further comprise any of the optional features of the first aspect.

The skilled person will appreciate that except where mutually exclusive, a feature or parameter described in relation to any one of the above aspects may be applied to any other aspect. Furthermore, except where mutually exclusive, any feature or parameter described herein may be applied to any aspect and/or combined with any other feature or parameter described herein.

Embodiments will now be described, by way of example only, with reference to the accompanying Figures, in which:

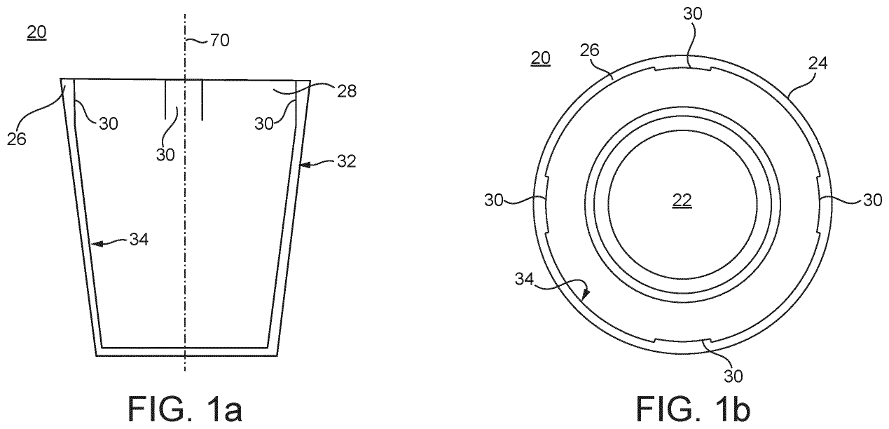

FIGS. 1a and 1b show respectively a side cross sectional view and a top view of a first example container;

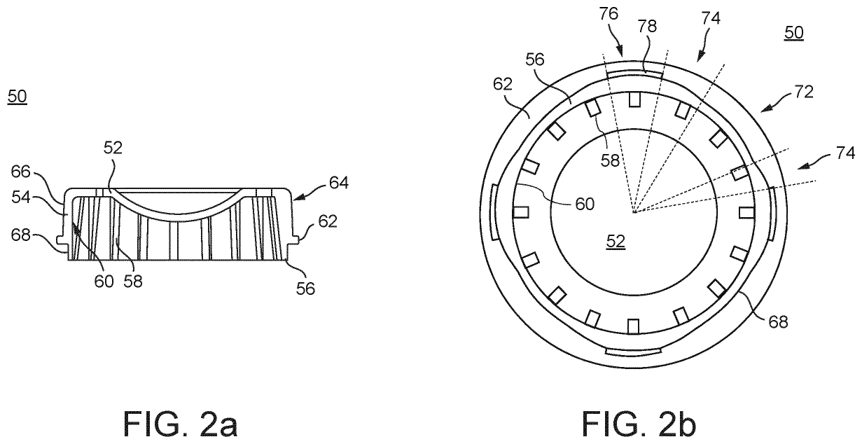

FIGS. 2a and 2b show respectively a side cross sectional view and a bottom view of a first example lid;

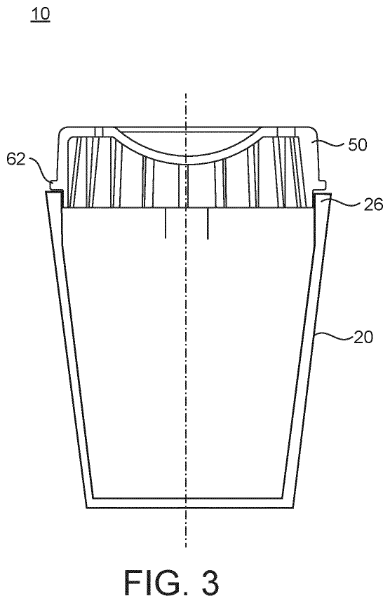

FIG. 3 shows a side cross-sectional view of a first example receptacle having the first example container and the first example lid;

FIG. 4 shows a second example receptacle having a second example lid;

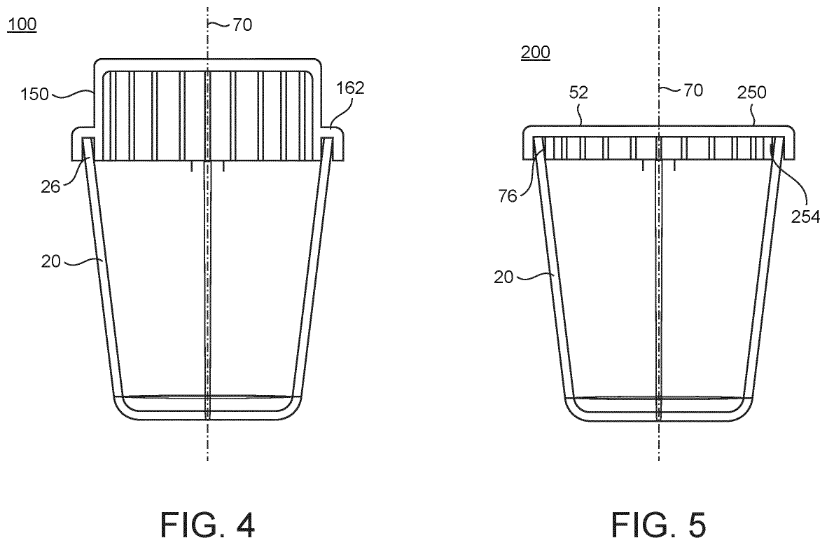

FIG. 5 shows a third example receptacle having a third example lid; and

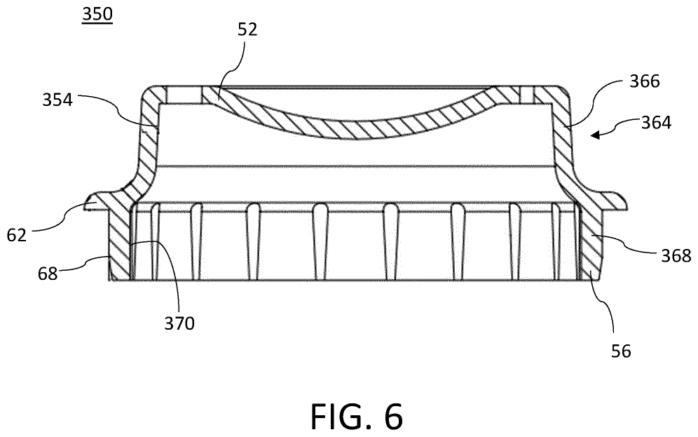

FIG. 6 shows a fourth example lid.

FIGS. 1a and 1b show a side cross sectional view of a first example container 20 and a top view of the container 20 respectively.

The first example container 20 is a cup comprising a container base 22 and a container side 24 defining a frustoconical shape extending along a central axis 70 from a periphery of the container base 22 so that a radius, from the central axis 70, of the container side 24 increases away from the container base 22, and terminates at a container rim 26. The container rim 26 defines a substantially circular opening 28 to provide access to an interior of the container 20.

The container 20 comprises a plurality of protruding locking tabs 30 which are disposed on an inner side surface 34 of the container side 24, at the container rim 26. In other examples, the locking tabs may be disposed on an outer side surface 32 of the container. In this example, the diameter of the inner side surface 34 is 72 mm such that the radius of the inner side surface 34 is 36 mm. The radius of the locking tab 30 in this example is 35.5 mm such that the difference in radius between the inner side surface 34 and the locking tab 30 is 0.5 mm.

In this example, there are four locking tabs 30 and the locking tabs 30 are evenly spaced around the circumference of the rim 26, such that they are spaced at 90 degree intervals. In other examples, there may be any suitable number of locking tabs.

In this example, the locking tabs 30 protrude from the inner side surface 34 of the container 20 such that they define a surface which is parallel to the central axis 70 in cross-section. In other words, the locking tabs 30 protrude from the inner side surface 34 such that the radius of the inner surface of the locking tab 30 from the central axis 70 is constant along the central axis 70. The rim 26 is therefore locally thicker at the locking tab 30, and therefore the radius of the rim 26 from the central axis 70 is locally smaller at the locking tab 30. In other examples, the locking tabs may protrude from the inner side surface so that the surface of the locking tab is at any angle up to parallel with the central axis in cross-section. In other words, the locking tab may protrude so that the radius of the inner surface of the locking tab increases along the central axis 70 from the base 22 (i.e. the angle of the surface of the locking tab is not a re-entrant angle from the inner surface of the container along the central axis). In yet other examples, the locking tabs may be protruding at any angle.

Having the locking tabs 30 protruding to be parallel to the central axis 70, or angled so that the inner surface of the locking tab 30 it is not re-entrant along the central axis 70 from the container base 22, means that the container 20 can be made with a punch die.

FIGS. 2a and 2b show respectively a cross-sectional view of a first example lid 50 and a bottom view of the lid 50. The lid 50 is configured to be received in the opening 28 of the container 20 to close the container 20. The lid 50 and the container 20 are configured to lock together with a rotational friction lock to form a first example receptacle 10, best shown in FIG. 3.

The lid 50 comprises a lid base 52 and a lid side 54 extending from a periphery of the lid base 52. The lid side 54 defines a cylindrical profile and terminates at a lid rim 56. A plurality of buttresses 58 are disposed on an inner side surface 60 of the lid side 54 to confer additional strength to the lid 50. An annular rim stop 62 is disposed around an outer side surface 64 of the lid side 54, and is configured to rest on the container rim 26 when the lid 50 is received in the opening 28 of the container 20. The rim stop 62 separates the outer side surface 64 of the lid 50 into two parts: a holding surface 66 and a locking surface 68. The holding surface 66 is defined between the rim stop 62 and the base 52 of the lid 50, and the locking surface 68 is on an opposing side of the annular rim stop 62 to the holding surface 66. In other examples, the rim stop 62 may not be annular, and may instead comprise a plurality of semi-annular rim stops disposed around the circumference of the outer side surface of the lid.

When the lid 50 is received on the container 20 such that the rim stop 62 is resting on the container rim 26, the lid side 54 is partially received within the container 20, and the locking surface 68 opposes the inner side surface 34 of the container 20. The locking surface 68 comprises a profile which is configured to lock with the locking tabs 30 of the container 20 by friction, which will be explained in more detail below. Cooperation of the rim stop 62 with the container rim 26 ensures that the lid 50 cannot be inserted further into the container 20.

In other examples, the locking surface may define a generally frustoconical shape such that the outer diameter of the lid increases from the lid rim towards the lid base. In such an example, cooperation of the locking surface with the inner side surface of the container when the lid is received on the container prevents further insertion of the lid into the container. Therefore, in such an example no rim stop is required to seat the lid on the container, and in some examples there may be no rim stop. In such examples, cooperation between the rim stop 62 and the container rim 26, or between the locking surface and the inner side surface may provide a moisture or air barrier. The frustoconical shape defined by the locking surface may have the same angle as the frustoconical shape defined by the container. In yet further examples, the frustoconical shape of the locking surface may have a different angle to the container such that the radius of the locking surface increases more quickly between the lid rim and the lid base than the radius of the container increases from the container base to the container rim.

In yet further examples, the container may define a lid rim stop in the form of a shelf protruding from an inner surface of the container and configured for the lid rim to rest on. The lid rim stop may be in addition to, or instead of, the rim stop on the lid.

The locking surface 68 comprises a receiving portion 72, a locking portion 74 and a stop portion 76, best shown in FIG. 2b. There are four receiving portions 72, evenly distributed around the locking surface 68, such that they are spaced at 90 degrees from each other. Each receiving portion 72 corresponds to a locking tab 30 of the container. Therefore, in an example with one, two, three or more locking tabs, there may be a corresponding number of receiving portions.

The receiving portion 72 of the locking surface 68 comprises a constant outer radius, and the radii of each receiving portion 72 are the same, which in this example is the minimum radius of the locking surface 68. In this example, the outer radius of the receiving portion may be 35.5 mm, which is the same as the radius of the locking tab 30. The receiving portion 72 is configured to receive a locking tab 30 of the container 20 with minimum or no friction. Therefore, the outer radius of the receiving portion 72 may be the same as, or marginally smaller than the inner radius of the locking tab 30 of the container 20. For example, the outer radius of the receiving portion may be 0.1 mm smaller than the inner radius of the locking tab 30.

When placing the lid 50 on the container 20, the receiving portions 72 and the locking tabs 30 are aligned so that there is minimal or no resistance, or friction to placing the 50 on the container 20 at the opening 28 of the container 20. The rotational friction lock comprises the locking portions 74 and the locking tabs 30, as will be described in more detail below.

In this example, there are locking portions 74 disposed on either side of each receiving portion 72, such that there are eight locking portions 74. Each locking portion 74 is adjacent to a receiving portion 72 adjacent to a stop portion 76 on an opposing side of the locking portion 74 to the receiving portion 72 (i.e. each locking portion 74 is between a receiving portion 72 and a stop portion 76). The locking portions 74 are contiguous with the adjacent receiving portion 72. The locking portions 74 define a continuous surface from the adjacent receiving portion 72 to the adjacent stop portion 76 where the continuous surface has a varying radius, which varies from the minimum at the receiving portion 72 to a maximum radius where it meets the stop portion 76. Therefore, when the lid 50 is placed on the container 20 such that the rim stop 62 abuts the container rim 26 and the receiving portions 72 oppose the locking tabs 30, rotation of the lid 50 in either direction about the central axis 70 relative to the container 20, results in engagement of the locking portion 74 with the locking tab 30 and friction between the locking tab 30 and a locking portion 74 varying. Since the locking portion 74 profile varies from a minimum outer radius to a maximum outer radius, rotating the lid 50 with respect to the container 20 increases the friction between the locking tab 30 and the locking portion 74 of the locking surface 68 up to a maximum friction. In this example, the radius of the locking portion 74 where it meets the stop portion 76 may be 36 mm, which is the same as the radius of the inner side surface 34. Therefore, in this example, the radius of the locking portion 74 varies from 35.5 mm to 36 mm between the receiving portion 72 and the stop portion 76. In other examples, the radius of the locking portion may vary by more or less than 0.5 mm. For example, the radius of the locking portion may be more than 36 mm where it meets the stop portion, such that the locking portion engages the locking tab of the container with less relative rotation.

Rotation of the lid 50 relative to the container 20 is limited by the stop portion 76, which comprises a protruding stop 78, configured to abut against the locking tab 30 of the container 20 to prevent further rotation. In this example, one stop portion 76 comprising a stop 78 is disposed between two locking portions 74 such that one stop 78 is shared by two locking portions 74.

In some examples, there may be only one locking portion adjacent to each receiving portion and a stop portion disposed adjacent to each locking portion. In other examples, there may be no receiving portions, and there may be two adjacent locking portions which meet at a point having a minimum radius. In yet other examples, there may be only locking portions with no adjacent stop portions, and no adjacent receiving portions.

FIG. 3 shows a first example receptacle 10 comprising the first example container 20 and the first example lid 50.

The lid 50 is received in the opening 28 of the container 20, and the rim stop 62 of the lid 50 rests on the rim 26 of the container 20. In use, the lid 50 is initially received in the opening such that the locking tabs 30 and the receiving portions 72 are aligned, so as to enable placement of the lid 50 on the container 20 with minimal friction or resistance. The lid 50 is then rotated relative to the container 20 about the central axis 70 so that the locking portions 74 of the lid 50 each engage with a respective locking tab 30, until the stop 78 of the stop portion 76 abuts the locking tab 30 to limit further rotation. The engagement of the locking portions with the locking tabs 30 generates friction between the lid 50 and the container 20 such that the lid 50 and the container 20 are locked together.

In this example, the components of the receptacle 10, i.e. the container 20 and the lid 50, are made of an edible material. The container 20 is made of a baked hard dough, such as a bread dough, and the lid 50 is made of a baked liquid dough comprising potato flour. In some examples, only the container or the lid may comprise an edible material, or the lid may comprise the baked dough and the container may be made from the potato flour dough. In other examples, the lid and/or container may comprise any biodegradable material. In yet other examples, the lid and/or the container may comprise any suitable material.

In this example, the components of the receptacle 10 i.e. container 20 and the lid 50, are fluid tight, such that the receptacle is suitable for containing a fluid. In this example, the receptacle is also suitable for containing a food. In other examples, only the container of the receptacle may be watertight, and suitable for containing fluid, such that the receptacle is suitable for containing a fluid. In yet other examples, the container and the lid may not be fluid tight, and as such, may not be suitable for containing a fluid.

Making the lid or container with a material comprising potato flour, corn flour, wheat flour, rice flour, rye flour, oat flour, oat bran flour or potato starch, corn starch, wheat starch, rice starch, rye starch, oat starch, a combination of these, or any material which becomes sticky (adhesive) on contact with a fluid, assists in locking the lid to the container when the receptacle is used to hold a fluid.

The lid 50 or container 20 may further comprise an acid, such as vinegar. Adding an acid to the material for the lid or the container which comprises a starch increases the hardness of the lid or container and the water resistance.

In this example, the locking portion of the lid 50 is also coated with an edible adhesive, such as honey, glucose syrup, a corn starch solution or a solution of water and sugar, to assist with locking the lid 50 and the container 20 together. In other example, the may be no adhesive, or the adhesive may not be edible.

The container 20 and the lid 50 are configured to lock together with only the rotational friction lock. Therefore, there are no other means of locking the container 20 and the lid 50 together. For example, there are no portions of the container which are captive between portions of the lid along the central axis; and there are no portions of the lid which are captive between portions of the container along the axis, when the container and the lid are locked together with, for example, a screw connection or a snap-fit connection.

In other words, the container is not sandwiched between portions of the lid along the central axis, and the lid is not sandwiched between portions of the container along the central axis, when the container and the lid are locked together.

Having a receptacle 10 comprising a container 20 and lid 50 which are configured to lock only with the rotational friction lock, enables the container and the lid to be manufactured simply and efficiently using punch dies.

FIG. 4 shows a cross sectional view of a second example receptacle 100. The second example receptacle comprises the first example container 20 and a second example lid 150.

The second example lid 150 is similar to the first example lid 50 and differs only in having a rim stop 162 which is annular and disposed on the outer side surface of the lid 150, and is further configured to extend around an outer surface of the rim 26 of the container 20. In other words, the rim 26 of the container 20 is sandwiched between the locking portion 74 and the rim stop 162 of the lid 150. This may provide additional strength to the rotational friction lock as the rim stop 162 may limit deformation of the rim 26 of the container 20, due to the varying radius of the locking portion 74 when rotating the lid 50. This may also provide a better moisture or air barrier, as it provides a further contact surface between the container 20 and the lid 50.

FIG. 5 shows a cross sectional view of a third example receptacle 200. The third example receptacle 200 comprises the first example container 20 and a third example lid 250.

The third example lid 250 is similar to the first example lid 50 and the second example lid 150. The third example lid 250 differs from the first example lid 50 and the second example lid 150 in that there is no holding surface on a side 254 of the lid 250. Rather, the side 254 which extends from a base 252, comprises a locking surface 68 only, and a rim stop 162 extending from the side 254. The rim stop 162 is similar to the rim stop 162 in the second example lid 150. In other examples, the rim stop may be similar to the rim stop in the first example lid 50.

In further examples, the container and the lid may comprise any suitable accessories, such as a drinking hole, a drinking straw extending from the lid, or holes for releasing or preventing a vacuum in the receptacle during use.

FIG. 6 shows a cross-sectional view of a fourth example lid 350 which is similar to the first example lid 50 in that it comprises a lid base 52 and a lid side 354 extending from the periphery lid base 52. The lid side 354 terminates at a lid rim 56 and a rim stop 62 is disposed around an outer side surface 364 of the lid side 354. The rim stop 62 is configured to rest on the container rim of a container when the lid 50 is received in the opening of the container.

The rim stop 62 separates the lid side 354 of the fourth example lid 350 into two parts: a holding portion 366 and a locking portion 368 comprising an outer locking surface 68, which is similar to the locking surface 68 on the first example lid 50.

The holding portion 366 has a cylindrical profile and the locking portion 368 has a cylindrical profile. An outer surface of the holding portion 366 has a diameter which is smaller than a diameter of an inner surface 370 of the locking portion 368. This enables the lid to be efficiently stacked for storage and transport, as the holding portion 366 can be received within an opening defined by the lid rim 56, and within the locking portion 368 of the lid side 354.

In some examples, the profile of the holding portion and the locking portion may be frustoconical rather than cylindrical, and the largest diameter of the outer surface of the holding portion may be smaller than the smallest diameter of the inner surface of the locking portion to enable efficient stacking.

In other examples, the lid may not have a rim stop, and the profile of the lid side may have a variable or stepped diameter to achieve a similar effect with a holding portion and a locking portion.

Although it has been described that the locking tabs are disposed on the container and the locking surface comprising a locking portion is defined on the surface of the lid, it will be appreciated that in some examples, the locking tabs may be on the lid and the locking surface with a locking portion may be defined on the surface of the container. The locking tabs may be on an inner surface of the lid, or may be on an outer surface of the lid, and the corresponding locking profile may be on an opposing surface of the container.

Although it has been described that there are four locking tabs and a least four corresponding receiving portions and locking portions, in some examples, there may be only one, two or three locking tabs, or there may be more than four locking tabs, and there may be a corresponding number of receiving portions and a corresponding number, or more, locking portions.

Having at two locking portions which are disposed on approximately opposing sides, or more than two locking portions ensures that there is symmetry in the friction holding the lid and the container together.

It will be understood that the invention is not limited to the embodiments above-described and various modifications and improvements can be made without departing from the concepts described herein. Except where mutually exclusive, any of the features may be employed separately or in combination with any other features and the disclosure extends to and includes all combinations and sub-combinations of one or more features described herein.

1. A receptacle comprising:
a container having an opening, the opening having a circular profile and the container extending from a base to the opening along a central axis; and
a lid for closing the opening of the container;
wherein the lid and container are configured to lock together with only a rotational friction lock, the rotational friction lock comprising a protruding locking tab on a surface of the container or the lid and a locking surface profile defined on the other of the lid or the container, such that there are no portions of the container which are captive between portions of the lid along the central axis; and there are no portions of the lid which are captive between portions of the container along the central axis, when the container and the lid are locked together;
wherein the locking surface is configured to oppose the locking tab when the lid closes the opening of the container, the locking surface having a locking portion, and the locking portion having a continuous surface with a varying radius such that friction between the locking tab and the locking portion varies on relative rotation between the lid and the container.

2. A receptacle according to claim 1, wherein the locking tabs are on the container, and wherein the lid defines the locking surface profile having the locking portion.

3. A receptacle according to claim 2, wherein the locking tabs are disposed on an inner surface of the container, and wherein the locking portion of the lid is on an outer surface of the lid.

4. A receptacle according to claim 2, wherein the lid comprises a lid base and a lid side extending from the base, the lid side terminating at a lid rim, wherein the locking surface is defined on the lid side and defines a frustoconical shape such that an outer diameter of the lid side increases from the lid rim towards the lid base.

5. A receptacle according to claim 1, wherein the locking surface comprises a stop adjacent to the locking portion, to limit rotation of the lid with respect to the container.

6. A receptacle according to claim 1, wherein the locking surface profile comprises a receiving portion adjacent to the locking portion which is configured to receive the locking tab with minimal friction when the lid is initially placed on the opening of the container.

7. A receptacle according to claim 6, wherein there is a locking portion disposed on either side of the receiving portion.

8. A receptacle according to claim 1, wherein there are at least two locking tabs, and at least two corresponding locking portions.

9. A receptacle according to claim 1, wherein the lid and/or the container is made of biodegradable material.

10. A receptacle according to claim 1, wherein the lid and/or the container is made of edible material.

11. A receptacle according to claim 1, wherein the lid or the container comprises material which becomes stickier on contact with liquid, such as potato flour or potato starch.

12. A receptacle according to claim 1, wherein the lid or the container comprises material including an acid in combination with starch.

13. A receptacle according to claim 1, wherein the locking surface is coated with an edible adhesive.

14. A receptacle according to claim 1, wherein the container opening is defined by a rim, and wherein the lid comprises a rim stop protruding from a surface of the lid, wherein the rim stop is configured to rest on the rim of the container when the lid is received in the container opening.

15. A receptacle according to claim 14, wherein an upper surface of the rim which is configured to oppose the rim stop and/or a lower surface of the rim stop which is configured to oppose the rim is coated with an edible adhesive.

16. A receptacle according to claim 1, wherein the container extends from a base to the rim along a central axis, wherein the rim stop of the lid is configured to extend around the rim when the lid is received in the opening of the container, such that the rim is sandwiched between the locking portion and the rim stop in a direction perpendicular to the central axis.

17. A receptacle according to claim 1, wherein the container extends from a base to the opening along a central axis, wherein the locking tab protrudes from the surface of the container or the lid such that the radius of the surface of the locking tab, from a central axis, is constant along the central axis, or such that the radius of the surface of the locking tab increases along the central axis from the base.

18. A receptable according to claim 1, wherein the lid comprises a lid base and a lid side extending from the base, the lid side terminating at a lid rim and the lid side comprising a locking portion adjacent the lid rim, and a holding portion adjacent the locking portion, wherein an outer surface of the holding portion comprises a diameter which is smaller than a diameter of an inner surface of the locking portion.

19. A receptacle comprising:
a container having an opening, the opening having a circular profile; and
a lid for closing the opening of the container;
wherein the lid and container are configured to lock together with a rotational friction lock, the rotational friction lock comprising a protruding locking tab on a surface of the container or the lid and a locking surface profile defined on the other of the lid or the container;
wherein the locking surface is configured to oppose the locking tab when the lid closes the opening of the container, the locking surface having a locking portion, and the locking portion having a continuous surface with a varying radius such that friction between the locking tab and the locking portion varies on relative rotation between the lid and the container,
wherein the lid or the container comprises material which becomes stickier on contact with liquid.

20. A receptacle according to claim 2, wherein the lid comprises a lid base and a lid side extending from the base, the lid side terminating at a lid rim, wherein the locking surface is defined on the lid side and defines a frustoconical shape such that an outer diameter of the lid side increases from the lid rim towards the lid base.
